(19) United States
(12) Patent Application Publication
(10) Pub. No.: US 2012/0183844 A1
(43) Pub. Date: Jul. 19, 2012

(54) LID ASSEMBLY FOR BATTERY

(75) Inventors: Tadanobu OTA, Kiyosu-shi (JP); Yasunori UCHIDA, Kiyosu-shi (JP)

(73) Assignee: TOYODA GOSEI CO., LTD., Kiyosu-shi (JP)

(21) Appl. No.: 13/299,920

(22) Filed: Nov. 18, 2011

(30) Foreign Application Priority Data
Jan. 19, 2011 (JP) 2011-008804

(51) Int. Cl. H01M 2/30

(52) U.S. Cl. 429/179

(57) ABSTRACT

A lid assembly for battery includes a lid, and a pair of electrode terminals. One of the paired electrode terminals is provided with an electricity collector terminal, a rod-shaped penetrator, a flange and an external terminal that are made from out of a rod integrally by plastic forming.

INCORPORATION BY REFERENCE

The present invention is based on Japanese Patent Application No. 2011-8,804, filed on Jan. 19, 2011, the entire contents of which are incorporated herein by reference.

### BACKGROUND OF THE INVENTION

1. Field of the Invention

The present invention relates to a lid assembly for sealing the opening of battery container. The lid assembly is provided with a lid through which at least a pair of electrode terminals penetrate, for instance.

2. Description of the Related Art

Recently, lithium-ion secondary batteries have been attracting attentions as a source for supplying electric power to portable or mobile electric appliances, or even to electric vehicles, for instance, because lithium-ion secondary batteries not only have larger capacities or higher output powers but also exhibit higher energy densities.

A lithium-ion secondary battery is usually manufactured by putting a wound electrode assembly making an electric-power generating element within a battery container along with a nonaqueous electrolyte solution and then sealing an opening of the battery container with a lid assembly for battery.

FIG. 9 illustrates one of the conventional lid assemblies for battery in an exploded perspective view. The conventional lid assembly 100 for battery comprises a pair of electrode terminals (140, 140). The paired electrode terminals (140, 140) not only pierce through a lid 130 but also are f fixed to the lid 130. The paired electrode terminals (140, 140) are made up of an electricity collector terminal 142, and an external terminal (being also referred to as a letter-“Z”-shaped terminal occasionally) 144, respectively. The electricity collector terminal 142 is connected to anelectrode assembly inside a battery container, whereas the external terminal 144 is connected to a connector 160 outside the battery container. The electricity collector terminal 142 and external terminal 144 are not only coupled to each other, but also are fixed to the lid 130 firmly, by crimping a rivet 143. Note that the electricity collector terminal 142 is provided with the rivet 143 that penetrates through the lid 130. In addition, a sealing rubber 152 and a resinous lower gasket 153 intervenes between the electricity collector terminal 142 and the lid 130, and a resinous upper gasket 154 further interposes between the lid 130 and the external terminal 144.

However, the conventional lid assembly 100 for battery that has the above-described construction might have been associated with such a problem that it might suffer from increasing costs because it comprises so many component parts as described above. Moreover, another problem might have arisen in that the electric conductivity between the electricity collector terminal 142 and the external terminal 144 might be lower in the reliability because the paired electrode terminals (140, 140) are made up of the electricity collector terminal 142 and external terminal 144 that are integrated by crimping the rivet 143 adherently.

Incidentally, it is possible to divide the electricity collector terminal 142 into the rivet 143 and the other section (or an ordinary section) 141 from the viewpoint of configuration. The ordinary section 141 can be made of a raw plate-shaped material or workpiece with a thin wall thickness, because it can only be provided with a minimum cross-sectional area in order to conduct electricity. However, the rivet 143 requires a raw material or workpiece that has a thick wall thickness compared with that of the ordinary section 141, because it is necessary to flow the raw material greatly in order to make the coupling by riveting. As a result, another problem might have arisen as well in that the manufacture of the electricity collector terminal 142 might be poor in the yield or productivity of material, because the proportion of unused or wasted material might get greater as a consequence.

Japanese Unexamined Patent Publication (KOKAI) Gazette No. 11-329,380 discloses an intent to reduce the quantity of component parts by making the connection between an electricity connector terminal and a letter-“Z”-shaped terminal simpler in construction. However, the disclosure contributes less to improving the yield or productivity of material as well as to upgrading the reliability in terms of the electric conductivity between the electricity collector terminal and the letter-“Z”-shaped terminal.

### SUMMARY OF THE INVENTION

The present invention has been developed in view of the aforementioned circumstances. It is therefore an object of the present invention to provide a lid assembly for battery, lid assembly which comprises the least number of component parts possible and whose electrode terminals are not only upgraded in the reliability in terms of electric conductivity but also improved in the yield or productivity of material.

A lid assembly for battery according to the present invention comprises a lid, and a pair of electrode terminals that not only pierce through the lid but also are mounted on the lid, one of the paired electrode terminals comprising:

an electricity collector terminal being conductive electrically to an electrode;

a rod-shaped penetrator penetrating through the lid; a flange extending in a disk shape about the rod-shaped penetrator that makes an imaginary center axially;

an external terminal to be connected to an outside connector;

the electricity collector terminal, the rod-shaped penetrator, the flange and the external terminal being made from out of a rod integrally by plastic forming; and an engager operating cooperatively with the flange to hold the lid between itself and the flange, thereby fixing the lid by the flange and the engager.

It is preferable that the lid assembly for battery according to the present invention can further comprise an engagement groove that is impressed into the penetrator, and that the engager can include a snap ring to be engaged with the engagement groove.

Moreover, in the lid for battery according to the present invention, it is preferable that:

the rod can have a given outside diameter “d”;

the flange can have another given outside diameter “D”; and

“D”/“d,” a ratio of the latter outside diameter “D” to the former outside diameter “d,” can fall in a range of from 1.5 to 2.5.

In addition, it is preferable that the lid assembly for battery according to the present invention can further comprise a seal that intervenes between the penetrator and the lid in order to seal a space between the penetrator and the lid. Furthermore, it is more preferable that the seal can comprise a sealing rubber being deformed by a compressibility ratio that falls in a range of from 20 to 50% when being assembled. Note herein that the term, “compressibility ratio,” herein implies by how much ratio a sealing rubber can be deformed from its original configuration to a deformed configuration when being assembled. For example, the “compressibility ratio” can be determined by the following equation:

Compressibility Ratio (%)={(t₀−t₁)/t₀×100

where t₀ specifies an original thickness of a sealing rubber; and t₁ specifies a compressed thickness of the sealing rubber when being assembled.

The lid assembly for battery according to the present invention enables manufactures to reduce the quantity of component parts remarkably compared with conventional battery lid assemblies with the above-described construction, because the present battery lid assembly comprises a pair of the electrode terminals one of which is made from out of one and only rod integrally by plastic forming. Moreover, manufacturers can produce the present battery lid assembly in higher yield or productivity of material than they produce the conventional lid assemblies' electrode terminals that have been made by integrating two component parts by means of crimping, because the present battery lid assembly' s one of the paired electrode terminals is formed from out of a single and independent rod-shaped material or workpiece integrally. In addition, the present battery lid assembly makes inspections for electric conductivity nonessential or obsolete, because it can comprise the paired electrode terminals that are free from the conventional problem of electric conductivity between electrode terminals.

Moreover, the lid assembly for battery according to the present invention can further comprise a snap ring, which makes the engager to be engaged with an engagement groove that is impressed into the penetrator of one of the paired electrode terminals, thereby fixing one of the paired electrode terminals to the lid. In such a preferable mode, the snap ring, together with the flange, makes it possible to firmly hold the lid body between itself and the flange. Accordingly, it is possible to generate stable rigidity for securing the paired electrode terminals in place to the lid. In addition, since the preferable mode makes such a simplified construction for the fixing, the simplified construction enables the component parts (e.g., the engager or snap ring, and the penetrator with the engagement groove impressed) to fluctuate less in assembly accuracy. Consequently, it is possible to fix the paired electrode terminals to the lid highly accurately.

In addition, the lid assembly for battery according to the present invention can further comprise a seal that intervenes between the flange and the lid. As a result, the present battery lid assembly is upgraded in the function of sealing, because the seal reliably seals a space between the paired electrode terminals' rod-shaped penetrator and the lid through which the penetrator pierces.

### BRIEF DESCRIPTION OF THE DRAWINGS

A more complete appreciation of the present invention and many of its advantages will be readily obtained as the same becomes better understood by reference to the following detailed description when considered in connection with the accompanying drawings and detailed specification, all of which forms a part of the disclosure.

FIG. 1 is a schematic diagram for showing a construction of a lithium-ion secondary battery.

FIG. 2 is a perspective diagram for showing a lid assembly for battery according to one of embodiments of the present invention.

FIG. 3 is a cross-sectional diagram that is taken along the imaginary chain line “3”-“3” in FIG. 2.

FIG. 4 is a perspective diagram for showing an electrode terminal that is directed to the lid assembly for battery according to the present embodiment.

FIG. 5 is an explanatory diagram for illustrating steps of processing the lid assembly for battery according to the present embodiment: wherein FIG. 5A illustrates a rod stock prior to the processing steps; FIG. 5B illustrates the rod stock that has undergone the forging step; and FIG. 5C illustrates the rod stock that has undergone the bending step.

FIG. 6 is another explanatory diagram for illustrating other steps of processing the lid assembly for battery according to the present embodiment: wherein FIG. 6A illustrates a work-in-progress electrode terminal that is undergoing the assembling step; and FIG. 6B illustrates the work-in-progress electrode terminal that has undergone the assembling step.

FIG. 7 is still another explanatory diagram for illustrating still other steps of processing the lid assembly for battery according to the present embodiment: wherein FIG. 7A illustrates the work-in-progress electrode terminal that has undergone the pressing step; and FIG. 7B illustrates the work-in-progress electrode terminal that has undergone the bending step as well as the punching step.

FIG. 8 is a perspective diagram for showing a detent for preventing the electrode terminal of the lid assembly for battery according to the present embodiment from rotating or swinging.

FIG. 9 is an exploded perspective diagram for illustrating a conventional lid assembly for battery.

### DETAILED DESCRIPTION OF THE PREFERRED EMBODIMENTS

Having generally described the present invention, a further understanding can be obtained by reference to the specific preferred embodiments which are provided herein for the purpose of illustration only and not intended to limit the scope of the appended claims.

### Embodiment

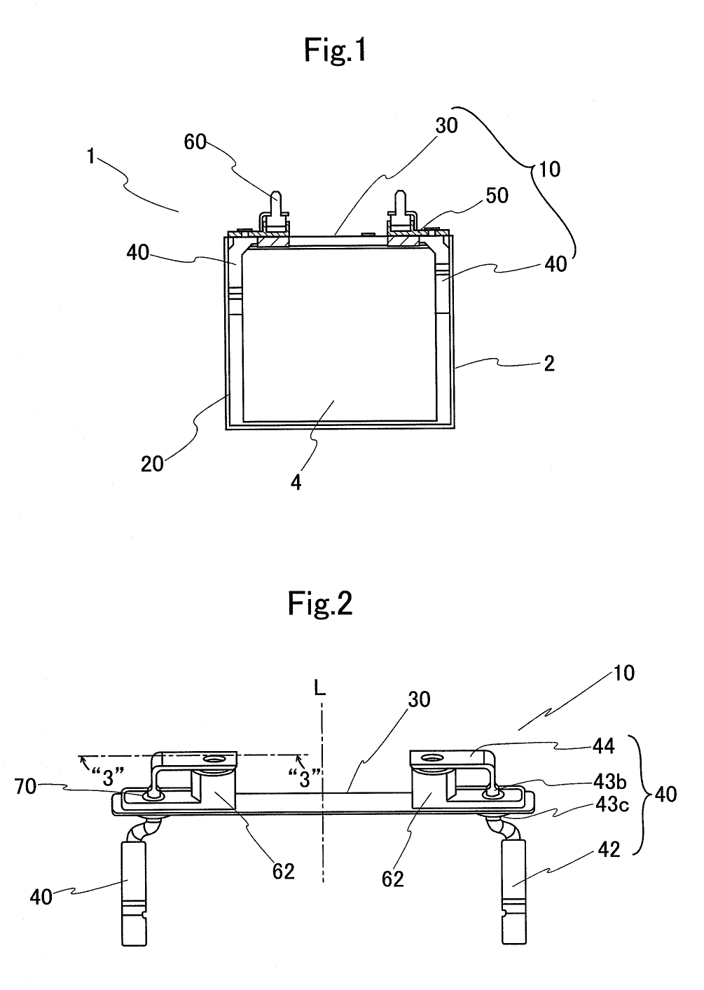

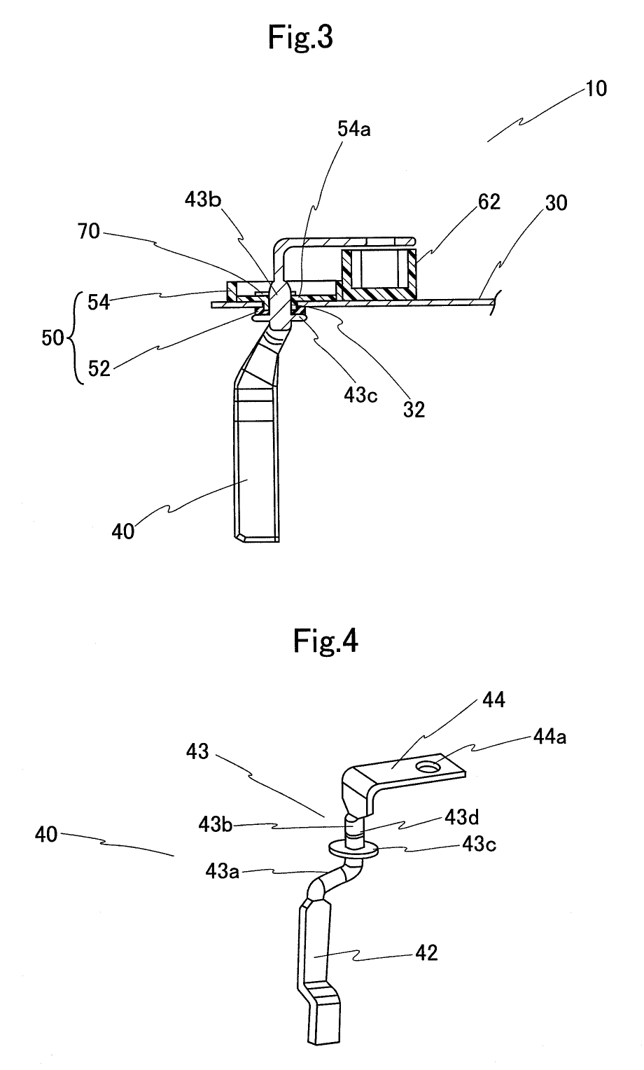

Hereinafter, one of embodiments of a lid assembly for battery according to the present invention will be described in detail with reference to the drawings. FIG. 1 shows a construction of a lithium-ion secondary battery 1 in a schematic diagram. FIG. 2 shows a lid assembly 10 for battery according to the present embodiment in a perspective diagram. FIG. 3 shows the lid assembly 10 in a cross-sectional diagram that is taken along the imaginary chain line “3”-“3” in FIG. 2.

As illustrated in FIG. 1, the lithium-ion secondary battery 1 comprises a container 2, an electrode assembly 4, a pair of electrode terminals (40, 40), and a pair of connectors (60, 60). The container 2 is formed as a rectangular parallelepiped shape substantially. The electrode assembly 4 is wound as a flattened shape, and is accommodated in the container 2. The paired electrode terminals (40, 40) are connected to the axial opposite ends of the electrode assembly 4 (i.e., the right and left opposite ends in FIG. 1). The paired connectors (60, 60) are connected electrically to the paired electrode terminals (40, 40) outside the container 2. Moreover, the container 2 holds a not-shown electrolytic solution therein. In addition, the electrode assembly 4 is immersed into the electrolytic solution.

The container 2 includes a box-shaped container body 20, and a lid 30. The container body 20 has an opening at the top. The lid 30 is attached to the opening of the container body 20, thereby sealing the container body 20. Note that the paired electrode terminals (40, 40) not only pierce through the lid 30 at the opposite ends, respectively, but also are fixed to the lid 30, thereby making the lid assembly 10 for battery according to the present embodiment, as shown in FIG. 2.

As illustrated in FIG. 2, the lid assembly 10 for battery according to the present embodiment is constructed virtually symmetrically with respect to the imaginary axis “L” that divides the lid 30 into the halves imaginarily in the longitudinal direction. Hence, descriptions will be hereinafter made mainly on the left-side section of the lid assembly 10 in the drawing.

As illustrated in FIG. 3, a seal 50 intervenes between the electrode terminal 40 and the lid 30. Specifically, the seal 50 includes a rubber seal 52, and a resin gasket 54. The rubber seal 52 comes in contact with the lid 30 from the inside, whereas the resin gasket 54 comes in contact with the lid 30 from the outside. An engager 70 (e.g., a letter-“E”-shaped snap ring) secures the electrode terminal 40 in place to the lid 30 by way of the seal 50, namely, the rubber seal 52 and resin gasket 54.

Hereinafter, descriptions will be made in detail on the electrode terminal 40, one of the constituent elements of the lid assembly 10 for battery according to the present embodiment. FIG. 4 illustrates the electrode terminal 40 in a perspective diagram. As shown in the drawing, the electrode terminal 40 comprises a flat electricity collector terminal 42, an external terminal 44, and a penetrator 43. The electricity collector terminal 42 is to be joined with one of the opposite ends of the electrode assembly 4. The external terminal 44 is to be connected to one of the paired connectors (60, 60). The penetrator 43 not only unites the electricity collector terminal 42 with the external terminal 44, and but also pierces through the lid 30.

The penetrator 43 is provided with a bent section 43a, and a rod-shaped upright section 43b. The bent section 43a extends from the top end of the electricity collector terminal 42 virtually horizontally toward one of the shorter sides of the lid 30. The upright section 43b extends upward from the top end of the bent section 43a virtually perpendicularly. The upright section 43b is provided with a flange 43c. The flange 43c spreads in a disk shape about the upright section 43b serving as the imaginary center axially. Moreover, an engagement groove 43d is impressed into the upper outer periphery of the upright section 43b that is present above the flange 43c. The engagement groove 43d is to be engaged with the engager 70. In addition, the upright section 43b is made continually to and from the flat external terminal 44 that is flattened to extend horizontally. Furthermore, the external terminal 44 is provided with an insertion hole 44a into which one of the paired connectors (60, 60) is inserted.

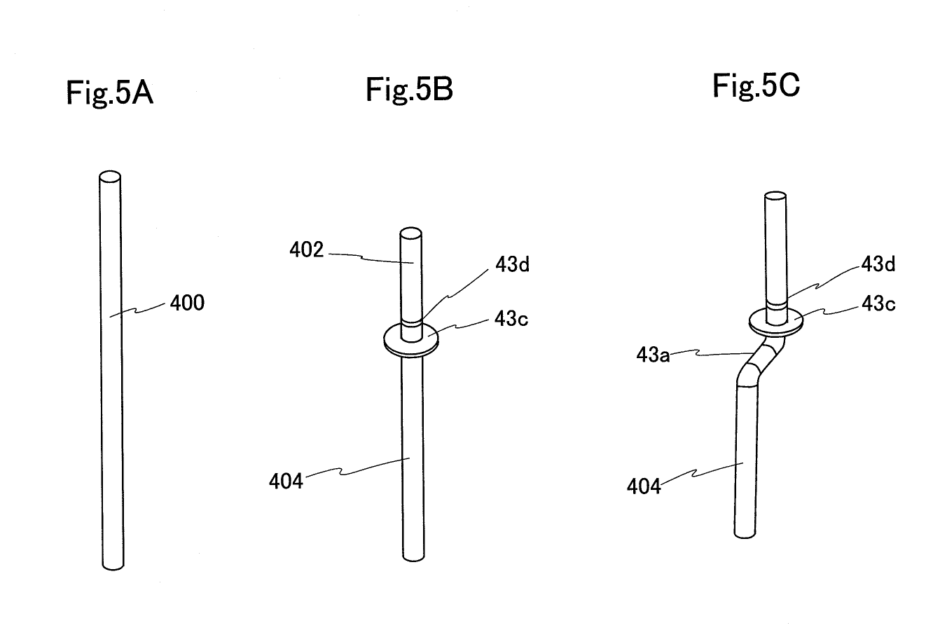

The lid assembly 10 for battery according to the present embodiment that comprises the above-described electrode terminal 40 can be manufactured with use of a rod stock 400, a material for making the electrode terminal 40, and the lid 30, a member for sealing the container body 20, as shown in FIGS. 5 through 7, for instance.

First of all, a cylindrical rod stock 400, a material for making the electrode terminal 40, is prepared, as shown in FIG. 5A. Then, the rod stock 400 is subjected to forging, thereby fluidizing the stock material in the longitudinal direction in order to form the flange 43c, as shown in FIG. 5B. Note herein that, when the rod stock 400 has an outside diameter “d” and the flange 43c has an outside diameter “D,” it is preferable that “D”/“d,” a ratio of the latter outside diameter to the former outside diameter, can fall in a range of from 1.5 to 2.5. When the ratio “D”/“d” is less than 1.5, the rubber seal 52 might not produce sealing property fully because the flange 43c serves as the seat for the rubber seal 52. Moreover, the flange 43c scarcely exhibits rigidity fully for fastening the completed electrode terminal 40 in place to the lid 30. In addition, it is needless to say that the flange 43c has an outside diameter “D” that is less than the length of the minor sides of the lid 30. Subsequently, the engagement groove 43d is impressed into an outer peripheral face of a rod-stock upper section 402 in the rod stock 400 above the flange 43c. The engagement groove 43d can either be formed by machining, or be depressed by pressing. Thereafter, the rod stock 400 is subjected to bending at its lower section 404 below the flange 43c, thereby providing it with the above-described bent section 43a, as shown in FIG. 5C.

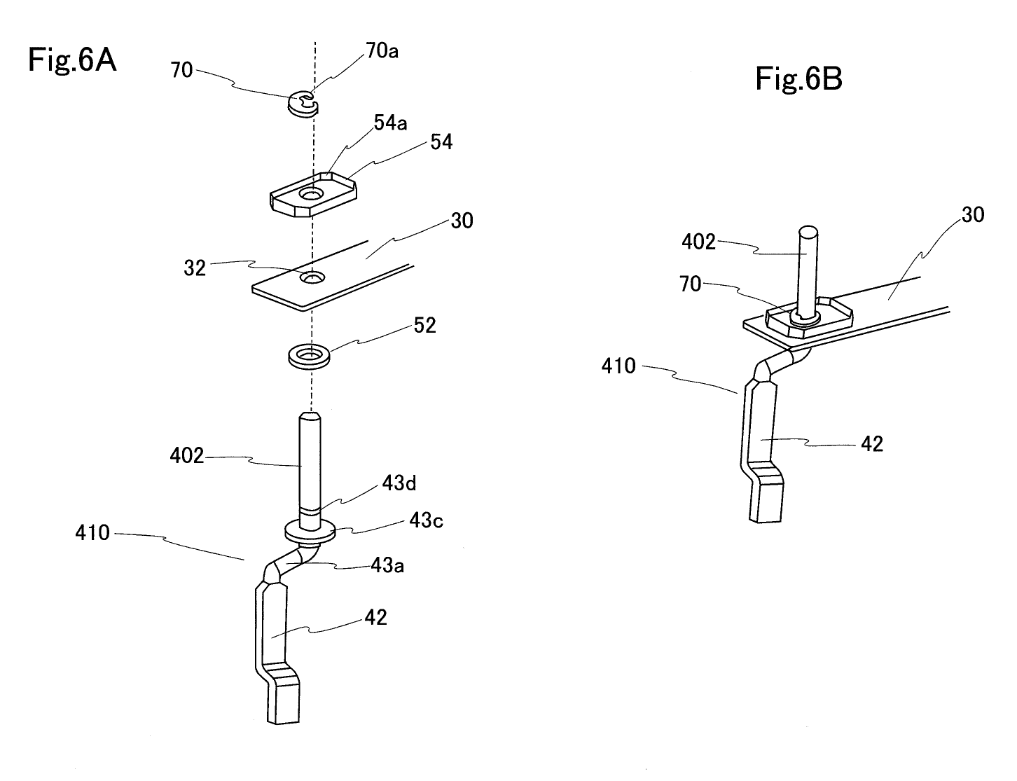

Then, the rod stock 400 is subjected to pressing as well as bending at the rod-stock lower section 404 below the bent section 43a. Thus, a work-in-progress electrode terminal 410 with the prescribed electricity collector terminal 42 formed is manufactured, as shown in FIG. 6. Moreover, as illustrated in FIG. 6A, the rod-stock upper section 402 of the work-in-progress electrode terminal 410 is pierced into the rubber seal 52, the lid 30, and the resin gasket 54 in this order, thereby stacking them on the flange 43c. After the assembly operation, the engager 70 is engaged with the engagement groove 43d of the work-in-progress electrode terminal 410 in order to secure the work-in-progress electrode terminal 410 in place to the lid 30. Note that the engager 70 is not limited herein in particular and accordingly it is possible to use snap rings, such as letter-“E”-shaped snap rings or clip-like snap rings, for the engager 70. In addition, the rubber seal 52 can preferably exhibit a compressibility ratio of from 20 to 50%. When the rubber seal 52 exhibits a compressibility ratio of less than 20%, the rubber seal 52 might not produce sealing property fully between the flange 43c and the lid 30. On the contrary, when the rubber seal 52 exhibits a compressibility ratio of more than 50%, the sealing rubber 52 might break or rupture under an extraordinary compressive load. The compressibility ratio can more preferably fall in a range of from 30 to 40%.

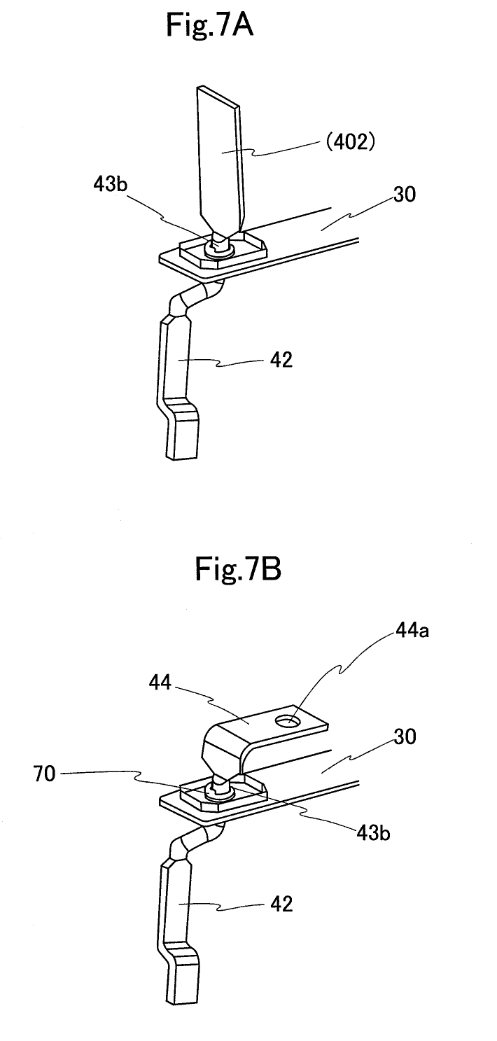

Subsequently, the rod-stock upper section 402, which protrudes from out of the lid 30, is pressed in order to turn it into a flat plate-like shape, as shown in FIG. 7A. Then, the resultant flattened rod-stock upper section 402 is bent horizontally, and is thereafter punched out at around the leading end in order to form the insertion hole 44a, as shown in FIG. 7B. Thus, the external terminal 44 is completed. Moreover, as illustrated in FIG. 2, a fastener 62 for fastening one of the paired connectors (60, 60) is put place on the top face of the lid 30, which faces the insertion hole 44a of the external terminal 44. For example, the faster 62 can be a resinous member into which a nut is inserted in order to secure the connector 60 in place with the screw.

Except for forming the electrode terminal 40 integrally from out of the rod stock 400, it is possible to manufacture the lid assembly 10 for battery according to the present embodiment in the same manner as having been heretofore done conventionally. For example, a metal, which is selected from the group consisting of aluminum, aluminum alloys, copper and copper alloys, can be employed appropriately to make the rod stock 400. Moreover, ethylene-propylene copolymer (or EPDM), or nitrile rubber (or acrylonitrile-butadiene rubber (or NBR)) can be used suitably to make the rubber seal 52, which intervenes between the flange 43c and the lid 30, in the same manner as having been heretofore used conventionally in making the rubber seal 152 of the conventional lid assembly 100 for battery according to the prior art. Moreover, a resin seal, which is made from a resin such as tetra fluoro ethylene-perfluoro alkylvinyl ether copolymer (or PFA), can substitute for the rubber seal 52.

The lid assembly 10 for battery according to the present embodiment, which has been assembled as described above, comprises the paired electrode terminals (40, 40) that are manufactured from out of the one and only rod stock 400. That is, the paired electrode terminals (40, 40) can be produced by turning the single and independent rod stock 400 into the predetermined configuration by means of plastic forming, respectively. Accordingly, unlike the manufacture of the paired electrode terminals (140, 140) in the conventional lid assembly 100, it is not required to prepare an extra material for making some of the parts, such as the rivet 143, for instance. Consequently, it is possible for manufacturers to complete the present lid assembly 10 comprising the paired electrode terminals (40, 40) in a better yield or productivity of material than to manufacture the prior art lid assembly 100 comprising the paired electrode terminals (140, 140), because the paired electrode terminals (140, 140) have been heretofore made conventionally by integrating a plurality of component parts, such as the electricity collector terminal 142 and letter-“Z”-shaped external terminal 144 to be riveted together. Moreover, the present lid assembly 10 enables manufacturers to do away with electric continuity tests that have been heretofore carried out conventionally, because it has solved the problem of the electricity continuity from the paired electricity collector terminals (143, 143) to the paired external terminals (144, 144), or vice versa, in the conventional lid assembly 100. That is, the paired electrode terminals (40, 40) are free from the problem of the electricity conductivity between the electricity collector terminal 42 and the external terminal 44.

The lid assembly for battery according to the present invention is not limited to the above-described present embodiment. The lid assembly for battery according to the present embodiment can be changed or modified in such ranges that the changes or modifications do not deviate or depart from the spirit or scope of the present invention.

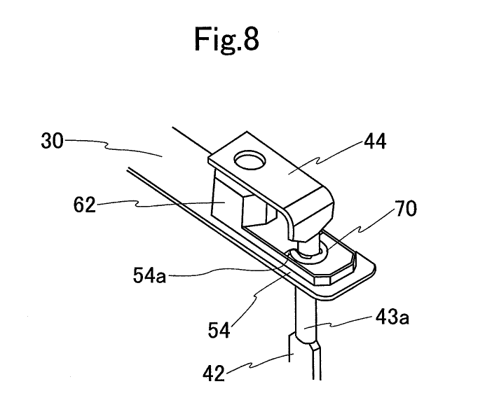

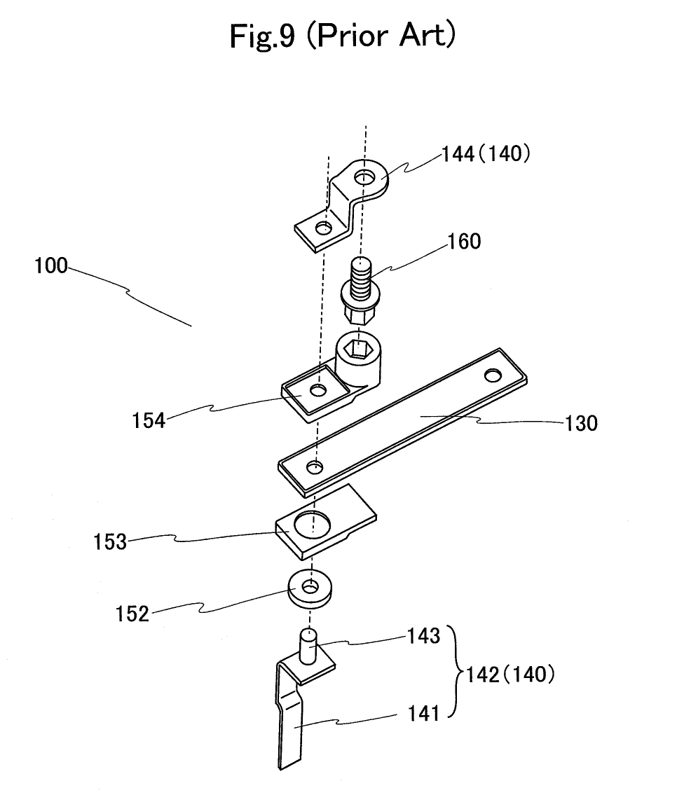

For example, the resin gasket 54 can be provided with a step or shoulder 54a, as shown in FIG. 8. Since the thus formed step or shoulder 54a interferes with the opposite ends of the engager 70, the step or shoulder 54a can prevent one of the paired electrode terminals (40, 40) from rotating or swinging about the rod-shaped penetrator 43b, which serves as the imaginary center axially, against the resin gasket 54.

Moreover, the lid assembly 10 for battery according to the present embodiment comprises the resin gasket 54 and fastener 62 that are made independently of each other. However, the present lid assembly 10 can also comprise one and only component part that is provided with the resin gasket 54 and fastener 62 integrally. The integration enables manufactures to furthermore reduce the quantity of component parts for making the present lid assembly 10.

### INDUSTRIAL APPLICABILITY

It is possible to employ the lid assembly for battery according to the present invention suitably as lid assemblies for square-shaped sealed batteries that make power sources or electric sources for electric vehicles or portable electronic appliances.

Having now fully described the present invention, it will be apparent to one of ordinary skill in the art that many changes and modifications can be made thereto without departing from the spirit or scope of the present invention as set forth herein including the appended claims.

What is claimed is:

1. A lid assembly for battery, the lid assembly comprising a lid, and a pair of electrode terminals that not only pierce through the lid but also are mounted on the lid, one of the paired electrode terminals comprising:
an electricity collector terminal being conductive electrically to an electrode;
a rod-shaped penetrator penetrating through the lid;
a flange extending in a disk shape about the rod-shaped penetrator that makes an imaginary center axially;
an external terminal to be connected to an outside connector;
the electricity collector terminal, the rod-shaped penetrator, the flange and the external terminal being made from out of a rod integrally by plastic forming; and
an engager operating cooperatively with the flange to hold the lid between itself and the flange, thereby fixing the lid by the flange and the engager.

2. The lid assembly according to claim 1 further comprising an engagement groove that is impressed into the penetrator, wherein the engager includes a snap ring to be engaged with the engagement groove.

3. The lid assembly according to claim 1, wherein:
the rod has a given outside diameter “d”;
the flange has another given outside diameter “D”; and
“D”/“d,” a ratio of the latter outside diameter “D” to the former outside diameter “d, ” falls in a range of from 1.5 to 2.5.

4. The lid assembly according to claim 1 further comprising a seal that intervenes between the penetrator and the lid in order to seal a space between the penetrator and the lid.

5. The lid assembly according to claim 4, wherein the seal comprises a sealing rubber being deformed by a compressibility ratio that falls in a range of from 20 to 50% when being assembled.

6. The lid assembly according to claim 1 further comprising a detent for inhibiting one of the paired electrode terminals from rotating or swinging.

7. The lid assembly according to claim 1, wherein the paired electrode terminals comprise the electricity collector terminal, the rod-shaped penetrator, the flange and the external terminal that are made from out of a rod integrally by plastic forming, and the engager, respectively.
